(19) United States
(12) Patent Application Publication
(10) Pub. No.: US 2016/0345323 A1
(43) Pub. Date: Nov. 24, 2016

(54) DYNAMIC FREQUENCY SELECTION PROCEDURES IN WIRELESS MODEMS

(71) Applicant: QUALCOMM Incorporated, San Diego, CA (US)

(72) Inventors: Parthasarathy KRISHNAMOORTHY, San Diego, CA (US); Prashanth MOHAN, Chennai (IN); Nithin Thilak NALLASIVAM, Coimbatore (IN); Tao LUO, San Diego, CA (US); Wanshi CHEN, San Diego, CA (US); Kuo-Chun LEE, San Diego, CA (US); Aravinth RAJENDRAN, Hyderabad (IN)

(21) Appl. No.: 14/715,308

(22) Filed: May 18, 2015

(51) Int. Cl. H04W 72/04; H04W 16/14

(52) U.S. Cl. CPC H04W 72/0453; H04W 16/14; H04W 72/042; H04W 84/042

(57) ABSTRACT

Aspects of the present disclosure provide a system, method, and apparatus for implementing an intelligent Dynamic Frequency Selection (DFS) procedure that avoids unnecessary scanning of an unlicensed or shared spectrum, and hence offers efficient power utilization for user equipments (UEs). In one aspect, one or more UEs may periodically identify at least one of a current operating frequency, a mode of operation, and the public land mobile network (PLMN) associated with the UE to determine whether the UE is operating in a DFS channel. Based on the above-identified factors, the UE may determine whether the UE is actively scheduling uplink data transmission on the DFS channel, and thus dynamically enable or disable the DFS scanning procedures on the unlicensed or shared spectrum.

### BACKGROUND

The various aspects described in this disclosure relate generally to wireless communications systems, and more particularly, to dynamic frequency selection (DFS) procedures in wireless modems.

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code division multiple access (CDMA) systems, time division multiple access (TDMA) systems, frequency division multiple access (FDMA) systems, and orthogonal frequency division multiple access (OFDMA) systems, (e.g., an LTE system).

By way of example, a wireless multiple-access communications system may include a number of base stations, each simultaneously supporting communication for multiple communication devices, which may be otherwise known as user equipment (UEs), mobile devices or stations (STAs). A base station may communicate with the communication devices on downlink channels (e.g., for transmissions from a base station to a UE) and uplink channels (e.g., for transmissions from a UE to a base station).

During the past few decades, wireless technology has seen a tremendous growth with introduction of high-end mobile devices that contribute towards ever-increasing bandwidth demands. However, as cellular networks have become more congested, operators are beginning to look at ways to maximize the use of available network resources. One approach may include utilizing an unlicensed or shared spectrum (e.g., 5 Giga Hertz (GHz) band) to schedule traffic between the base station and the one or more communication devices. However, regulatory agencies such as the Federal Communications Commission (FCC), European Telecommunications Standards Institute (ETSI), along with other foreign regulatory bodies have promulgated strict requirements to operate in a portion of the 5 GHz band in which DFS is used. DFS is a mechanism or procedure that allows wireless devices to share unlicensed spectrum with mission critical systems (e.g., weather radars and/or non-civilian applications) by having the wireless device switch between channels to avoid interfering with the mission critical systems. Based on regulatory requirements, a communications device (e.g., UE) operating in the unlicensed or shared spectrum is to periodically scan channels in the unlicensed or shared spectrum to prevent against interfering with the mission critical systems. If the scanning or monitoring of DFS channels detects such mission critical systems operating in the unlicensed or shared spectrum, the communications device is then to leave the respective DFS channel within a designated time. However, the need to scan for radar signals, for example, necessitates long scan intervals that interrupt traffic scheduling, and often results in poor power consumption.

### SUMMARY

Aspects of the present disclosure provide a system, method, and apparatus for implementing an intelligent Dynamic Frequency Selection (DFS) procedure that avoids unnecessary scanning of the unlicensed or shared spectrum, and hence offers efficient power utilization for the user equipments (UEs). In one aspect, one or more UEs may periodically identify at least one of a current operating frequency, a mode of operation, and the public land mobile network (PLMN) associated with the UE to determine whether the UE is operating in the DFS channel. Based on the above-identified factors, the UE may determine whether the UE is actively scheduling uplink data transmission on the DFS channel, and thus dynamically enable or disable the DFS scanning procedures on the unlicensed or shared spectrum.

According to a first set of illustrative embodiments, a method for wireless communication is described. In some aspects, the method may include identifying, at a UE, at least one of a current operating frequency of the UE, mode of operation of the UE, or a wireless network associated with the UE. The method may further include determining whether the UE is operating in a DFS channel based on the at least one of the current operating frequency of the UE, the mode of operation of the UE, or the wireless network associated with the UE and configure the UE to dynamically enable or disable a DFS procedure based on the determining.

According to a second set of illustrative embodiments, an apparatus for wireless communication is described. The apparatus may include means for identifying, at a UE, at least one of a current operating frequency of the UE, mode of operation of the UE, or a wireless network associated with the UE. The apparatus may further include means for determining whether the UE is operating in a DFS channel based on the at least one of the current operating frequency of the UE, the mode of operation of the UE, or the wireless network associated with the UE and means for configuring the UE to dynamically enable or disable a DFS procedure based on the determining.

According to a third set of illustrative embodiments, a computer-readable medium storing code for wireless communications is described. The code may comprise instructions executable by a computer to identify, at a UE, at least one of a current operating frequency of the UE, mode of operation of the UE, or a wireless network associated with the UE. The instructions may further be configured to determine whether the UE is operating in a DFS channel based on the at least one of the current operating frequency of the UE, the mode of operation of the UE, or the wireless network associated with the UE and configure the UE to dynamically enable or disable a DFS procedure based on the determining.

According to a fourth set of illustrative embodiments, another apparatus for wireless communications is described. The apparatus may include a processor and a memory coupled to the processor. The memory may comprise instructions executable by the processor to identify, at a UE, at least one of a current operating frequency of the UE, mode of operation of the UE, or a wireless network associated with the UE. The instructions may further be configured to determine whether the UE is operating in a DFS channel based on the at least one of the current operating frequency of the UE, the mode of operation of the UE, or the wireless network associated with the UE and configure the UE to dynamically enable or disable a DFS procedure based on the determining.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

The disclosed aspects of the present disclosure will hereinafter be described in conjunction with the appended drawings, provided to illustrate and not to limit the disclosed aspects, wherein like designations denote like elements, where a dashed line may indicate an optional component, and in which:

FIG. 1 illustrates an example of a wireless communications system for an Dynamic Frequency Selection (DFS) procedure in accordance with various aspects of the present disclosure;

FIG. 2 illustrates another example of the wireless communications system for implementing the DFS procedure in accordance with various aspects of the present disclosure;

FIG. 3 illustrates an example of a schematic diagram of a user equipment (UE) comprising various components and subcomponents in accordance with various aspects of the present disclosure;

FIG. 4 illustrates an example of a flowchart performed by the UE in accordance with various aspects of the present disclosure;

FIG. 5 illustrates another example of a flowchart performed by the UE in accordance with various aspects of the present disclosure; and

FIG. 6 is a diagram illustrating an example of a hardware implementation for an apparatus employing a processing system.

### DETAILED DESCRIPTION

Various aspects are now described with reference to the drawings. In the following description, for purposes of explanation, numerous specific details are set forth to provide a thorough understanding of one or more aspects. It should be understood, however, that such aspect(s) may be practiced without these specific details. Also, as used herein, a component may be one of the parts that make up a system, may be hardware or software, and may be divided into other components.

As discussed above, congestion on the traditional licensed band (e.g., 2.4 GHz band) has motivated network operators to offload wireless wide area network (WWAN) traffic to the unlicensed or shared spectrum (e.g., 5 GHz band) in order to meet the ever-growing bandwidth demands. However, due to restrictions imposed by various regulatory agencies against the use of the one or more Dynamic Frequency Selection (DFS) channels, UEs operating in the unlicensed or shared spectrum periodically scan the unlicensed or shared spectrum to ensure against inflicting interference on weather radars and/or non-civilian applications operating in the same channel. Scanning or monitoring the unlicensed or shared spectrum for radar signals, for example, may require the UE to interrupt traffic on the modem and refocus resources and power on the scanning of the unlicensed or shared spectrum. However, depending on the public land mobile network (PLMN) and the geographic region (e.g., coutry) where the UE is operating, the one or more reserved DFS channels within the unlicensed or shared spectrum may vary remarkably. Hence, unnecessary data interruptions and scanning for interference on the unlicensed or shared spectrum may negatively impact the data throughput rates and power consumption for the UEs.

Aspects of the present disclosure avoid such unnecessary scanning of the unlicensed or shared spectrum by first considering factors such as current operating frequency of the UE, a mode of operation of the UE, and the PLMN associated with the network prior to initializing the DFS procedure. Based on the consideration of the above-identified factors, the UE may determine whether the UE is actively scheduling uplink data traffic on a DFS channel, and thus dynamically enable or disable the DFS scanning procedures on the unlicensed or shared spectrum. Such an approach may prevent data interruption and offer efficient power utilization for the UEs.

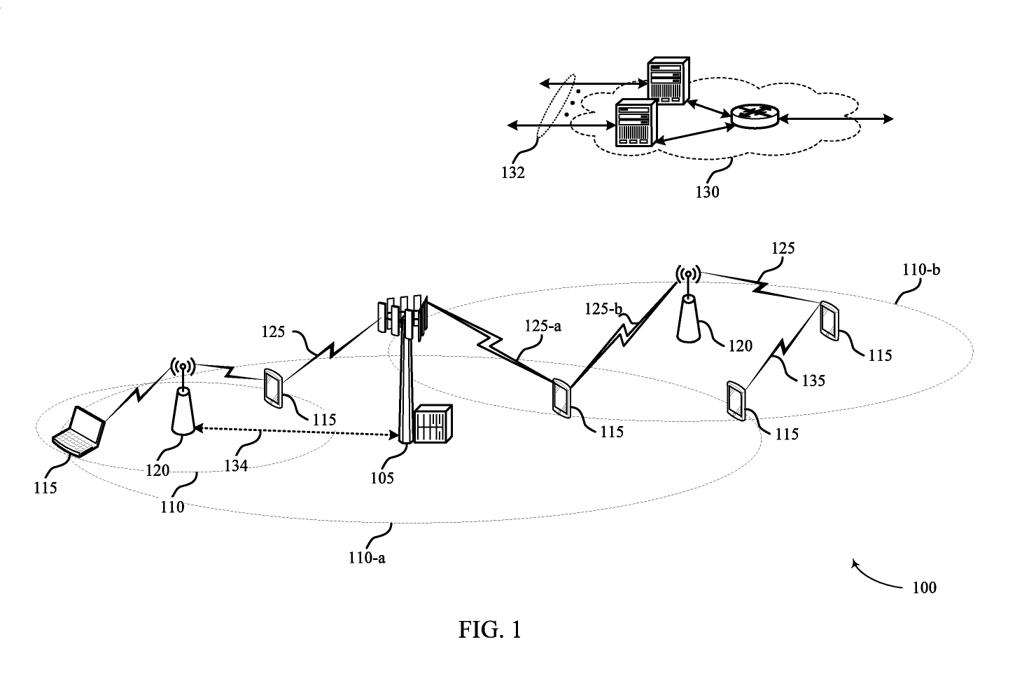

FIG. 1 illustrates an example of a wireless communications system for intelligently enabling or disabling DFS procedure in accordance with various aspects of the present disclosure. The system 100 includes base stations 105, small cell access points (AP) 120, mobile devices 115, and a core network 130. In some aspects of the present disclosure, the base station 105 may be referred to as a macro cell base station, and AP 120 may be referred to as small cell base station. The core network 130 may provide user authentication, access authorization, tracking, internet protocol (IP) connectivity, and other access, routing, or mobility functions. The base stations 105 may interface with the core network 130 through backhaul links 132 (e.g., S1, etc.). The base stations 105 and AP 120 may perform radio configuration and scheduling for communication with the mobile devices 115, or may operate under the control of a base station controller (not shown). In various examples, the base station 105 and AP 120 may communicate, either directly or indirectly (e.g., through core network 130), with each other over backhaul links 134 (e.g., X2, Over-the-air (OTA) etc.), which may be wired or wireless communication links. In some aspects of the present disclosure, the base station 105 and AP 120 may share their respective timing parameters associated with communication scheduling.

The base station 105 and AP 120 may wirelessly communicate with the mobile device 115 via one or more antennas. Each of the base station 105 and AP 120 may provide communication coverage for a respective geographic coverage area 110. In some examples, base station 105 may be referred to as a base transceiver station, a radio base station, an access point, a radio transceiver, a NodeB, eNodeB (eNB), Home NodeB, a Home eNodeB, or some other suitable terminology. The geographic coverage area 110-a for a base station 105 and coverage area 110-b for AP 120 may be divided into sectors making up only a portion of the coverage area (not shown). The wireless communications system 100 may include base station 105 and AP 120 of different types (e.g., macro or small cell base stations). There may be overlapping geographic coverage areas 110 for different technologies.

While the mobile devices 115 may communicate with each other through the base station 105 and AP 120 using communication links 125, each mobile device 115 may also communicate directly with one or more other mobile devices 115 via a direct wireless link 135. Two or more mobile devices 115 may communicate via a direct wireless link 135 when both mobile devices 115 are in the geographic coverage area 110 or when one or more mobile devices 115 are within the AP geographic coverage area 110-b. Examples of direct wireless link 135 may include Wi-Fi Direct connections, connections established using a Wi-Fi Tunneled Direct Link Setup (TDLS) link, and other P2P group connections. In other implementations, other peer-to-peer connections or ad hoc networks may be implemented within the system 100.

In some examples, the wireless communications system 100 includes a wireless wide area network (WWAN) such as an LTE/LTE-Advanced (LTE-A) network. In LTE/LTE-A networks, the term evolved node B (eNB) may be generally used to describe the base stations 105, while the term user equipment (UEs) may be generally used to describe the mobile devices 115. The wireless communications system 100 may include a heterogeneous LTE/LTE-A network in which different types of eNBs provide coverage for various geographical regions. The wireless communications system 100 may, in some examples, also support a wireless local area network (WLAN). A WLAN may be a network employing techniques based on the Institute of Electrical and Electronics Engineers (IEEE) 802.11x family of standards (“Wi-Fi”). In some examples, each eNB or base station 105 and AP 120 may provide communication coverage for a macro cell, a small cell, or other types of cell. The term “cell” is a 3GPP term that can be used to describe a base station, a carrier or component carrier associated with a base station, or a coverage area (e.g., sector, etc.) of a carrier or base station, depending on context.

A macro cell generally covers a relatively large geographic area (e.g., several kilometers in radius) and may allow unrestricted access by mobile device 115 with service subscriptions with the network provider. A small cell is a lower-powered base station, as compared with a macro cell, that may operate in the same or different (e.g., licensed, unlicensed, etc.) frequency bands as macro cells. Small cells may include pico cells, femto cells, and micro cells according to various examples. A pico cell, for example, may cover a small geographic area and may allow unrestricted access by mobile device 115 with service subscriptions with the network provider. A femto cell may also cover a small geographic area (e.g., a home) and may provide restricted access by mobile device 115 having an association with the femto cell (e.g., mobile device 115 in a closed subscriber group (CSG), mobile device 115 for users in the home, and the like). An eNB for a macro cell may be referred to as a macro eNB. An eNB for a small cell may be referred to as a small cell eNB, a pico eNB, a femto eNB, or a home eNB. An eNB may support one or multiple (e.g., two, three, four, and the like) cells (e.g., component carriers). In some aspects of the present disclosure, the base station 105 may be referred to as a macro cell base station, and AP 120 may be referred to as small cell base station.

The wireless communications system 100 may support synchronous or asynchronous operation. For synchronous operation, the base stations 105 may have similar frame timing, and transmissions from different base stations 105 may be approximately aligned in time. For asynchronous operation, the base stations 105 may have different frame timing, and transmissions from different base stations 105 may not be aligned in time. The techniques described herein may be used for either synchronous or asynchronous operations.

The communication networks that may accommodate some of the various disclosed examples may be packet-based networks that operate according to a layered protocol stack. In the user plane, communications at the bearer or packet data convergence protocol (PDCP) layer may be IP-based. A radio link control (RLC) layer may perform packet segmentation and reassembly to communicate over logical channels. A medium access control (MAC) layer may perform priority handling and multiplexing of logical channels into transport channels. The MAC layer may also use hybrid automatic repeat request (HARQ) to provide retransmission at the MAC layer to improve link efficiency. In the control plane, the radio resource control (RRC) protocol layer may provide establishment, configuration, and maintenance of an RRC connection between a mobile device 115 and the base stations 105. The RRC protocol layer may also be used for core network 130 support of radio bearers for the user plane data. At the physical (PHY) layer, the transport channels may be mapped to physical channels.

The mobile devices 115 may be dispersed throughout the wireless communications system 100, and each mobile device 115 may be stationary or mobile. A mobile device 115 may also include or be referred to by those skilled in the art as a user equipment (UE), mobile station, a subscriber station, STA, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A mobile device 115 may be a cellular phone, a personal digital assistant (PDA), a wireless modem, a wireless communication device, a handheld device, a tablet computer, a laptop computer, a cordless phone, a wireless local loop (WLL) station, or the like. A mobile device may be able to communicate with various types of base stations and network equipment including macro eNBs, small cell eNBs, relay base stations, and the like. In some examples, a dual-radio UE 115-a, may include a WLAN radio (not shown) and a WWAN radio (not shown) that may be configured to concurrently communicate with base station 105 (using the WWAN radio) and with AP 120 (using the WLAN radio).

The communication links 125 shown in wireless communications system 100 may include uplink (UL) transmissions from a mobile device 115 to a base station 105 or AP 120, or downlink (DL) transmissions, from a base station 105 or AP 120 to a mobile device 115. The downlink transmissions may also be called forward link transmissions while the uplink transmissions may also be called reverse link transmissions. Each communication links 125 may include one or more carriers, where each carrier may be a signal made up of multiple sub-carriers (e.g., waveform signals of different frequencies) modulated according to the various radio technologies described above. Each modulated signal may be sent on a different sub-carrier and may carry control information (e.g., reference signals, control channels, etc.), overhead information, user data, etc. The communication links 125 may transmit bidirectional communications using frequency division duplex (FDD) (e.g., using paired spectrum resources) or time division duplex (TDD) operation (e.g., using unpaired spectrum resources). Frame structures may be defined for FDD (e.g., frame structure type 1) and TDD (e.g., frame structure type 2).

The communication links 125 may utilize resources of licensed spectrum or unlicensed spectrum, or both. Broadly speaking, the unlicensed spectrum in some jurisdictions may range from 600 Megahertz (MHz) to 6 Gigahertz (GHz), but need not be limited to that range. As used herein, the term “unlicensed spectrum” or “shared spectrum” may thus refer to industrial, scientific and medical (ISM) radio bands, irrespective of the frequency of those bands. An “unlicensed spectrum” or “shared spectrum” may refer to a spectrum used in a contention-based communications system. In some examples, unlicensed spectrum is the U-NII radio band, which may also be referred to as the 5 GHz or 5G band. In some aspects, the “unlicensed spectrum” may include spectrum that may be reserved for mission critical devices (e.g., radar and non-civilian systems). However, DFS channels within the “unlicensed spectrum” may vary significantly based on the PLMN and the country in which one or more UEs 115 are operating. By contrast, the term “licensed spectrum” or “cellular spectrum” may be used herein to refer to wireless spectrum utilized by wireless network operators under administrative license from a governing agency.

Accordingly, aspects of the present disclosure allow the UE 115 to determine whether the UE 115 is potentially operating in the DFS channel of the unlicensed or shared spectrum based on the current operating frequencies, modes of operation and the PLMN associated with the UE 115. If the UE 115 determines that it is engaged in active uplink transmission on the DFS channel, the UE 115 may enable the DFS procedure to avoid interfering with the mission critical devices. However, if the UE 115 determines that it is not engaged in an active uplink transmission on the DFS channel, the UE 115 may conserve power by disabling the DFS procedure and continue communicating with the network without undue interruptions.

Wireless communications system 100 may also support operation on multiple cells or carriers, a feature which may be referred to as carrier aggregation (CA) or multi-carrier operation. A carrier may also be referred to as a component carrier (CC), a layer, a channel, etc. The terms “carrier,” “component carrier,” “cell,” and “channel” may be used interchangeably herein. A mobile device 115 may be configured with multiple downlink CCs and one or more uplink CCs for carrier aggregation. Carrier aggregation may be used with both FDD and TDD component carriers.

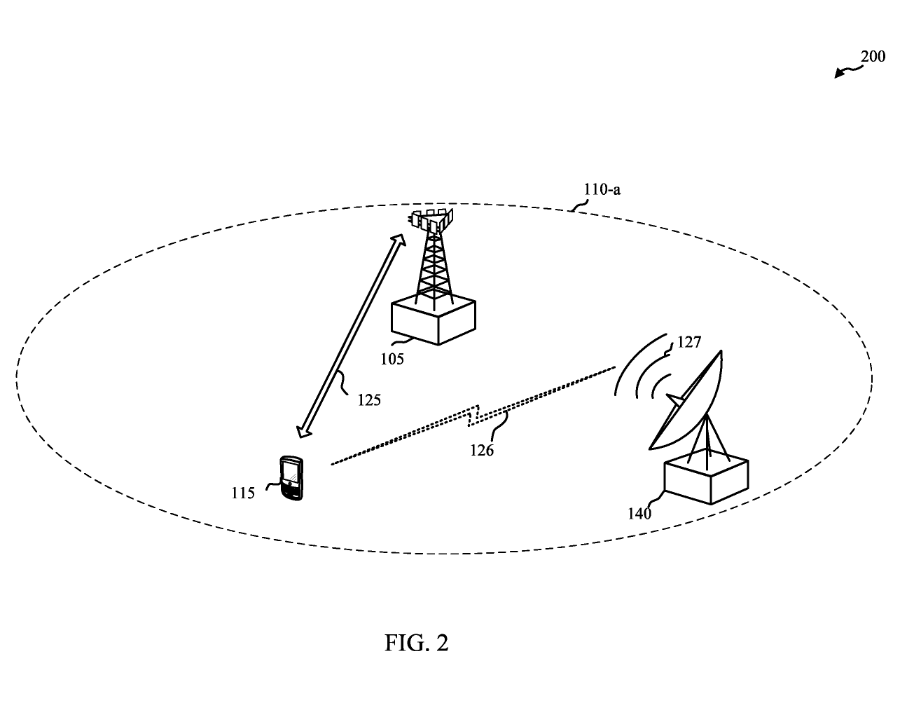

FIG. 2 illustrates another example of a wireless communications system 200 for intelligently enabling or disabling DFS procedure in accordance with various aspects of the present disclosure. In some aspects, the wireless communications system 200 may include a base station 105 that may be an example of base station 105 described with reference to FIG. 1. The wireless communications system 200 may also include a UE 115 that may be an example of UE 115 described with reference to FIG. 1.

In yet further examples, the wireless communications system 200 may include a mission critical system 140 (e.g., weather radars and/or non-civilian applications). Although FIG. 2 describes aspects of the present disclosure in terms of a radar system, it should be understood that any mission critical device (e.g., non-civilian application system) may be supplemented or substituted for the radar system. Accordingly, in accordance with various aspects of the present disclosure, the UE 115 may be configured to communicate with the base station 105 over an unlicensed or shared spectrum via communication link 125. The communication may comprise uplink and downlink traffic between the base station 105 and the UE 115 on the unlicensed or shared spectrum.

However, in some examples, different types of agencies may regulate the use of unlicensed or shared spectrum. In some aspects, the regulatory requirements may comprise allowing wireless devices (e.g., UE 115) to share unlicensed or shared spectrum with mission critical systems 140 (e.g., weather radars and/or military applications). Based on regulatory requirements, the UE 115 may operate in the unlicensed or shared spectrum so long as the UE 115 periodically scans channels in the unlicensed or shared spectrum to prevent against interference 126 of the mission critical systems 140. However, because the reserved DFS channels in the unlicensed or shared spectrum may vary based on the PLMN and the geographic region (e.g., different countries) in which the UE 115 is operating, aspects of the present disclosure avoid unnecessary scanning of the unlicensed or shared spectrum by periodically retrieving information associated with current operating frequency, current mode of operation, and/or PLMN from the UE's 115 memory. Based on the retrieved information, the UE 115 may determine whether the UE 115 is operating in a potential DFS channel and may cause interference 126 to the signal 127 of the mission critical systems 140.

However, even if, the UE 115 is operating in the DFS channel, that fact alone may not be dispositive for ceasing to communicate in the DFS channel. Instead, the UE 115 may further determine whether the UE 115 is actively transmitting or receiving traffic in the potential DFS channel based on a comparison to a table stored in the memory of the UE 115. If the UE 115 is actively engaged in an uplink traffic transmission, the UE 115 may enable the DFS procedure to scan the unlicensed or shared spectrum and scheduling the uplink traffic away from the DFS channel. Scheduling the uplink traffic away from the DFS channel may comprise either ceasing to transmit the uplink traffic on the DFS channel or schedule the uplink traffic on a non-DFS channel (e.g., another portion of the unlicensed band or a licensed band). Conversely, if the UE 115 determines that the UE 115 is engaged in receiving downlink traffic on the DFS channel, the UE 115 may disable the DFS procedure to conserve power.

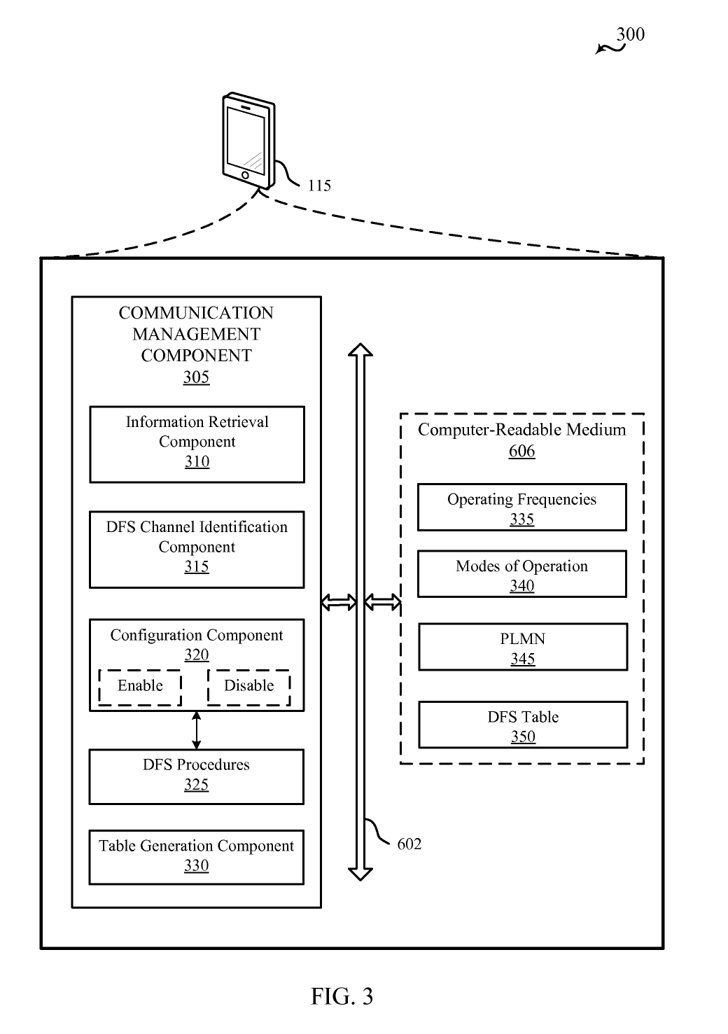

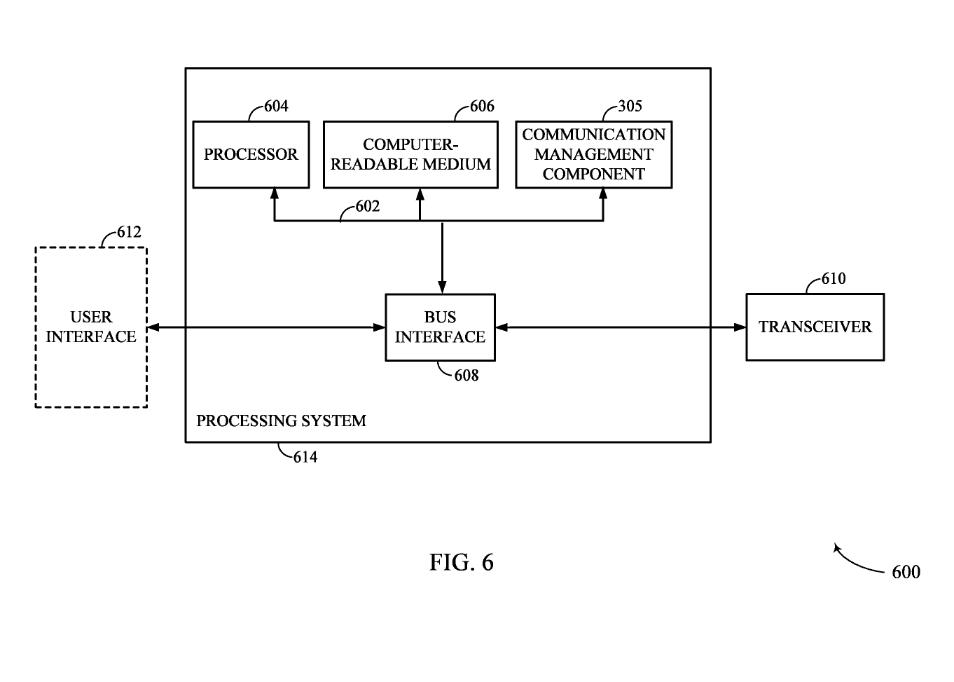

FIG. 3 shows a block diagram 300 of a UE 115 comprising a communication management component 305 configured to execute aspects of the present disclosure. In some examples, the UE 115 may be an example of one or more UEs 115 described with reference to FIGS. 1-2. The UE 115 may include a communication management component 305 and a computer-readable medium 606 (e.g., memory). Functions and methods described with reference to communication management component 305 may be performed by a processor (e.g., processor 604 in FIG. 6) or a separate processor implement in the UE 115. The communication management component 305 may communicate with the computer-readable medium 606 via bus 602 (see FIG. 6).

In accordance with various aspects of the present disclosure, the UE 115 may store in the computer-readable medium 606 information associated with the UE's 115 communication with the network. For example, the computer-readable medium 606 may maintain information corresponding to the operating frequencies 335 of the UE 115, various modes of operation 340 that the UE 115 is configured for and is presently maintaining with the network, PLMN 345 and the DFS table 350. In some aspects, the DFS table 350 may contain information regarding various radar and military reserved frequencies in one or more countries that the UE 115 may operate within. In yet further examples, the various modes of operation 340 may include configuring the UE 115 to utilize the unlicensed or shared spectrum as a primary carrier, a secondary carrier controlled by a licensed carrier, or the secondary carrier configured to schedule downlink traffic.

Additionally or alternatively, the UE 115 may also include a communication management component 305 that includes information retrieval component 310 for routinely (e.g., periodically) retrieving at least one of current operating frequency 335 of the UE 115, the mode of operation 340 of the UE 115, or the wireless network (e.g., PLMN) 345 associated with the UE 115. The information may be collected, received, or both, by the information retrieval component 310.

In some examples, the DFS channel identification component 315 may determine whether the UE is operating in a DFS channel based on the at least on the retrieved information by the information retrieval component 310. For example, the DFS channel identification component 315 may identify a list of DFS channels in a table (e.g., DFS table 350) associated with the PLMN 345 and determine that the current operating frequency 335 of the UE 115 corresponds with at least one channel on the list of DFS channels.

If the DFS channel identification component 315 determines that the UE 115 is operating on one or more DFS channels within the unlicensed or shared spectrum, the configuration component 320 may dynamically enable or disable a DFS procedure 325 (e.g., scanning and scheduling traffic away from DFS channels). In some aspects, the configuration component 320 may enable the DFS procedure based on determining that the UE 115 is operating on a DFS channel of the unlicensed or shared spectrum and that the UE 115 is actively transmitting uplink traffic on the DFS channel. Because uplink traffic on the DFS channel may interference with mission critical devices (e.g., radars and military application devices), enabling the DFS procedure 325 may include scheduling the uplink traffic away. In some examples, scheduling the uplink traffic away from the DFS channel may include at least one of a ceasing to transmit uplink traffic on the DFS channel or scheduling the uplink traffic on a non-DFS channel within the licensed, unlicensed or shared spectrum.

Additionally or alternatively, the communication management component 305 may also include a table generation component 330 configured to dynamically generate or revise the DFS table 350 which may list a number of DFS channels reserved within the unlicensed or shared spectrum corresponding with various PLMNs 345. Thus based on the region or country in the UE 115 may be operating, the DFS channel identification component 315 may be able to access the DFS table 350 and determine whether the current operating frequency of the UE 115 may be conflicting with a DFS channel of the unlicensed or shared spectrum.

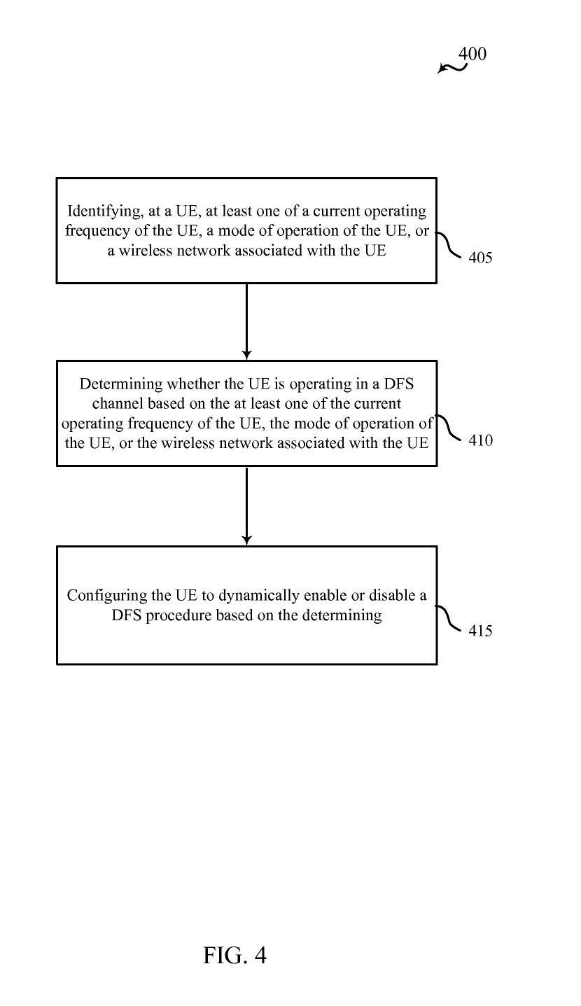

FIG. 4 is a flowchart conceptually illustrating an example of a method 400 of wireless communication, in accordance with aspects of the present disclosure. For clarity, the method 400 is described below with reference to ones of the UEs 115, described with reference to FIGS. 1-3.

At block 405, the method 400 may include identifying, at a UE, at least one of a current operating frequency of the UE, a mode of operation of the UE, or a wireless network associated with the UE. Aspects of the block 405 may be performed by information retrieval component 310 described with reference to FIG. 3.

At block 410, the method 400 may include determining whether the UE is operating in a DFS channel based on the at least one of the current operating frequency of the UE, the mode of operation of the UE, or the wireless network associated with the UE. Aspects of block 410 may be performed by DFS channel identification component 315 described with reference to FIG. 3.

At block 415, the method 400 may include configuring the UE to dynamically enable or disable a DFS procedure based on the determining. Aspects of block 415 may be performed by the configuration component 320 described with reference to FIG. 3.

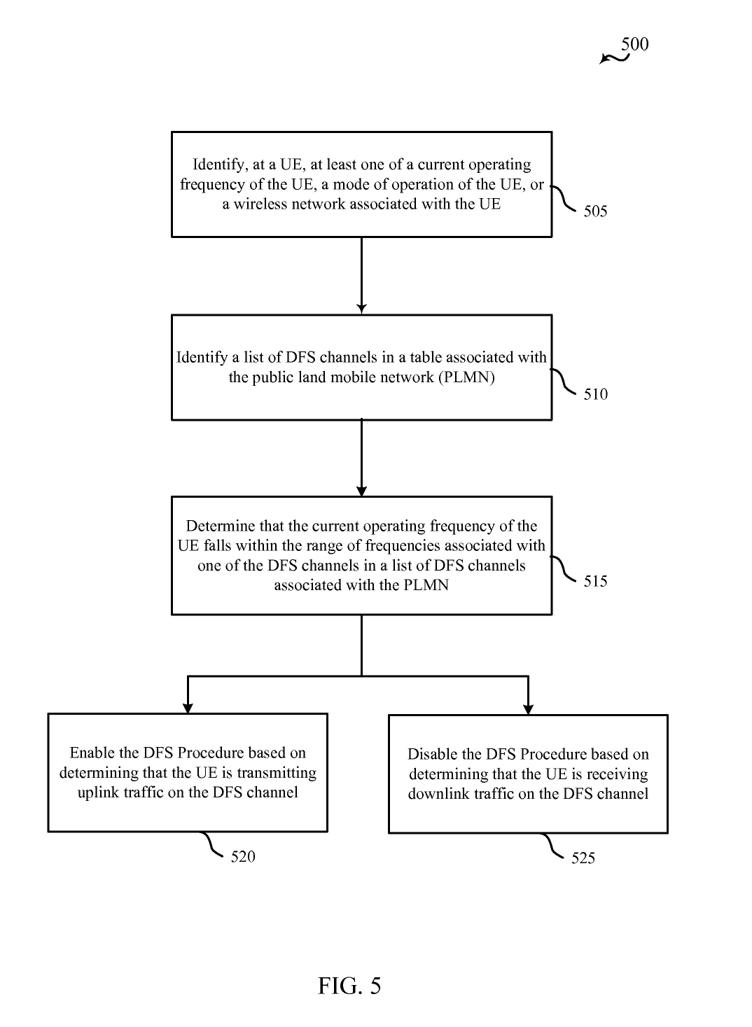

FIG. 5 is a flowchart conceptually illustrating an example of a method 500 of wireless communication, in accordance with aspects of the present disclosure. For clarity, the method 500 is described below with reference to ones of the UEs 115, described with reference to FIGS. 1-3.

At block 505, the method 500 may include identifying, at a UE, at least one of a current operating frequency of the UE, a mode of operation of the UE, or a wireless network (e.g., PLMN) associated with the UE. In some aspects, identifying the at least one of the current operating frequency of the UE, a mode of operation of the UE, or a wireless network associated with the UE may comprise periodically retrieving information from a memory (e.g., computer-readable medium 606) of the UE 115. In some aspects, the information may be collected, received, or both, by the UE 115. Additionally or alternatively, the current operating frequency may include one or more frequencies in the unlicensed or shared spectrum (e.g., 5 GHz band). The mode of operation may comprise utilizing the unlicensed or shared spectrum as a primary carrier, a secondary carrier controlled by a licensed carrier, or the secondary carrier configured to schedule downlink traffic. Aspects of the block 505 may be performed by information retrieval component 310 described with reference to FIG. 3.

At block 510, the method 500 may include identifying a list of DFS channels in a table associated with the PLMN. In some aspects, the UE 115 may review the DFS table 350 and determine whether the UE 115 is currently active on a potential DFS channel and whether the UE 115 is transmitting uplink traffic on the DFS channel. Aspects of block 510 may be performed by the DFS channel identification component 315 described with reference to FIG. 3.

At block 515, the method 500 may include determining that the current operating frequency of the UE falls within the range of frequencies associated with one of the DFS channels in a list of DFS channels associated with the PLMN. In some aspects, determining that the current operating frequency of the UE corresponds with at least one channel on the list of DFS channels comprises generating a revised DFS table that identifies a list of reserved DFS channels associated with different PLMNs. Thus, depending on the PLMN and/or country where the UE is operating, the UE 115 may intelligently determine whether the current operating frequency corresponds to a DFS channel listed in the DFS table 350. Aspects of the block 510 may be performed by the DFS channel identification component 315 described with reference to FIG. 3.

At block 520, the method 500 may include enabling the DFS procedure based on determining that the UE is transmitting uplink traffic on the DFS channel. Aspects of block 520 may be performed by configuration component 320 described with reference to FIG. 3. Conversely, even if the UE 115 is operating on the DFS channel, yet the operation is limited to receiving downlink traffic, the method 500, at block 525, may disable the DFS procedure based on the determining that the UE is receiving downlink traffic on the DFS channel. Aspects of block 520 may be performed by configuration component 320.

FIG. 6 is a conceptual diagram illustrating an example of a hardware implementation for an apparatus 600 employing a processing system 614. In some examples, the processing system 614 may be an example of a UE 115 described with reference to FIGS. 1-3. In this example, the processing system 614 may be implemented with a bus architecture, represented generally by the bus 602. The bus 602 may include any number of interconnecting buses and bridges depending on the specific application of the processing system 614 and the overall design constraints. The bus 602 links together various circuits including one or more processors, represented generally by the processor 604, computer-readable media, represented generally by the computer-readable medium 606, and/or communication management component 305 (see FIG. 3), which may be configured to carry out one or more methods or procedures described herein.

In some instances, the communication management component 305 may be implemented when processing system 614 is used in a UE 115. In an aspect, communication management component 305 and the components therein may comprise hardware, software, or a combination of hardware and software that may be configured to perform the functions, methodologies (e.g., method 400 of FIG. 4 and method 500 of FIG. 5), or methods presented in the present disclosure.

The bus 602 may also link various other circuits such as timing sources, peripherals, voltage regulators and power management circuits, which are well known in the art, and therefore, will not be described any further. A bus interface 608 provides an interface between the bus 602 and a transceiver 610. The transceiver 610 provides a means for communicating with various other apparatus over a transmission medium. Depending upon the nature of the apparatus, a user interface 612 (e.g., keypad, display, speaker, microphone, joystick) may also be provided.

The processor 604 is responsible for managing the bus 602 and general processing, including the execution of software stored on the computer-readable medium 606. The software, when executed by the processor 604, causes the processing system 614 to perform the various functions described infra for any particular apparatus. The computer-readable medium 606 may also be used for storing data that is manipulated by the processor 604 when executing software. In some aspects, at least a portion of the functions, methodologies, or methods associated with the communication management component 305 may be performed or implemented by the processor 604 and/or the computer-readable medium 606.

In some examples, the computer-readable medium 606 may store code for wireless communications. The code may comprise instructions executable by a computer (e.g., processor 604) to identify, at the UE, at least one of a current operating frequency of the UE, a mode of operation of the UE, or a wireless network associated with the UE. The code may further include instructions executable by the computer (e.g., processor 604) for determining whether the UE is operating in a DFS channel based on at least one of the current operating frequency of the UE, the mode of operation of the UE, or the wireless network associated with the UE. Additionally or alternatively, the code may further configure the UE to dynamically enable or disable a DFS procedure based on the determining.

The detailed description set forth above in connection with the appended drawings describes example embodiments and does not represent all the embodiments that may be implemented or that are within the scope of the claims. The term “exemplary,” as used in this description, means “serving as an example, instance, or illustration,” and not “preferred” or “advantageous over other embodiments.” The detailed description includes specific details for the purpose of providing an understanding of the described techniques. These techniques, however, may be practiced without these specific details. In some instances, well-known structures and devices are shown in block diagram form in order to avoid obscuring the concepts of the described embodiments.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof

The various illustrative blocks and modules described in connection with the disclosure herein may be implemented or performed with a general-purpose processor, a digital signal processor (DSP), an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or “as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, electrically erasable programmable read only memory (EEPROM), compact disk (CD) ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed herein.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1x, 1x, etc. IS-856 (TIA-856) is commonly referred to as CDMA2000 1xEV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc. UTRA and E-UTRA are part of Universal Mobile Telecommunications system (UMTS). 3GPP Long Term Evolution (LTE) and LTE-Advanced (LTE-A) are new releases of Universal Mobile Telecommunications System (UMTS) that use E-UTRA. UTRA, E-UTRA, UMTS, LTE, LTE-A, and Global System for Mobile Communications (GSM) are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies. The description above, however, describes an LTE system for purposes of example, and LTE terminology is used in much of the description above, although the techniques are applicable beyond LTE applications.

What is claimed is:

1. A method for wireless communication, comprising:
identifying, at a user equipment (UE), at least one of a current operating frequency of the UE, a mode of operation of the UE, or a wireless network associated with the UE;
determining whether the UE is operating in a dynamic frequency selection (DFS) channel based on the at least one of the current operating frequency of the UE, the mode of operation of the UE, or the wireless network associated with the UE; and
configuring the UE to dynamically enable or disable a DFS procedure based on the determining.

2. The method of claim 1, wherein determining whether the UE is operating in the DFS channel comprises:
identifying a list of DFS channels in a table associated with the wireless network; and
determining that the current operating frequency of the UE corresponds with at least one channel on the list of DFS channels.

3. The method of claim 2, further comprising:
enabling the DFS procedure based on determining that the UE is transmitting uplink traffic on the DFS channel; and
scheduling the uplink traffic away from the DFS channel upon enabling the DFS procedure, wherein scheduling the uplink traffic away from the DFS channel comprises at least one of a ceasing to transmit uplink traffic on the DFS channel or scheduling the uplink traffic on a non-DFS channel.

4. The method of claim 2, further comprising:
disabling the DFS procedure based on determining that the UE is receiving downlink traffic on the DFS channel.

5. The method of claim 1, further comprising:
generating a table of a plurality of DFS channels associated with a plurality of wireless networks, wherein the plurality of DFS channels includes the DFS channel, and wherein the plurality of wireless networks includes the wireless network associated with the UE.

6. The method of claim 5, wherein the plurality of DFS channels in the table associated with the plurality of wireless networks are reserved for mission critical system, wherein the mission critical system comprises at least one of a radar or a non-civilian application.

7. The method of claim 1, wherein determining whether the UE is operating in the DFS channel comprises:
determining that the UE is operating in an unlicensed or shared spectrum; and
detecting interference from a mission critical device on the unlicensed or shared spectrum, wherein the mission critical system comprises at least one of a radar or a non-civilian application.

8. The method of claim 1, wherein the current operating frequency of the UE is an unlicensed or shared spectrum; and
wherein the mode of operation comprises utilizing the unlicensed or shared spectrum as a primary carrier, a secondary carrier controlled by a licensed carrier, or the secondary carrier configured to schedule downlink traffic.

9. The method of claim 1, wherein the wireless network associated with the UE includes a public land mobile network (PLMN).

10. The method of claim 1, wherein identifying the at least one of the current operating frequency of the UE, the mode of operation of the UE, or the wireless network associated with the UE comprises periodically retrieving information from a memory of the UE, wherein the information is collected, received, or both, by the UE.

11. An apparatus for wireless communications, comprising:
means for identifying, at a user equipment (UE), at least one of a current operating frequency of the UE, a mode of operation of the UE, or a wireless network associated with the UE;
means for determining whether the UE is operating in a dynamic frequency selection (DFS) channel based on the at least one of the current operating frequency of the UE, the mode of operation of the UE, or the wireless network associated with the UE; and
means for configuring the UE to dynamically enable or disable a DFS procedure based on the determining.

12. The apparatus of claim 11, wherein means for determining whether the UE is operating in the DFS channel comprises:
means for identifying a list of DFS channels in a table associated with the wireless network; and
means for determining that the current operating frequency of the UE corresponds with at least one channel on the list of DFS channels.

13. The apparatus of claim 12, further comprising:
means for enabling the DFS procedure based on determining that the UE is transmitting uplink traffic on the DFS channel; and
means for scheduling the uplink traffic away from the DFS channel upon enabling the DFS procedure, wherein scheduling the uplink traffic away from the DFS channel comprises at least one of a ceasing to transmit uplink traffic on the DFS channel or scheduling the uplink traffic on a non-DFS channel.

14. The apparatus of claim 12, further comprising:
means for disabling the DFS procedure based on determining that the UE is receiving downlink traffic on the DFS channel.

15. The apparatus of claim 11, further comprising:
means for generating a table of a plurality of DFS channels associated with a plurality of wireless networks, wherein the plurality of DFS channels includes the DFS channel, and wherein the plurality of wireless networks includes the wireless network associated with the UE.

16. The apparatus of claim 15, wherein the plurality of DFS channels in the table associated with the plurality of wireless networks are reserved for mission critical system, wherein the mission critical system comprises at least one of a radar or a non-civilian application.

17. The apparatus of claim 11, wherein means for determining whether the UE is operating in the DFS channel comprises:
means for determining that the UE is operating in an unlicensed or shared spectrum; and
means for detecting interference from a mission critical device on the unlicensed or shared spectrum, wherein the mission critical system comprises at least one of a radar or a non-civilian application.

18. The apparatus of claim 11, wherein the current operating frequency of the UE is an unlicensed or shared spectrum; and
wherein the mode of operation comprises utilizing the unlicensed or shared spectrum as a primary carrier, a secondary carrier controlled by a licensed carrier, or the secondary carrier configured to schedule downlink traffic.

19. The apparatus of claim 11, wherein the wireless network associated with the UE includes a public land mobile network (PLMN).

20. The apparatus of claim 11, wherein means for identifying the at least one of the current operating frequency of the UE, the mode of operation of the UE, or the wireless network associated with the UE comprises means for periodically retrieving information from a memory of the UE, wherein the information is collected, received, or both, by the UE.

21. A computer-readable medium storing code for wireless communications, the code comprising instructions executable by a computer to:
identify, at a user equipment (UE), at least one of a current operating frequency of the UE, a mode of operation of the UE, or a wireless network associated with the UE;
determine whether the UE is operating in a dynamic frequency selection (DFS) channel based on the at least one of the current operating frequency of the UE, the mode of operation of the UE, or the wireless network associated with the UE; and
configure the UE to dynamically enable or disable a DFS procedure based on the determining.

22. The computer-readable medium of claim 21, wherein the instructions are further executable by the computer to:
identify a list of DFS channels in a table associated with the wireless network; and
determine that the current operating frequency of the UE corresponds with at least one channel on the list of DFS channels.

23. The computer-readable medium of claim 22, wherein the instructions are further executable by the computer to:
enable the DFS procedure based on determining that the UE is transmitting uplink traffic on the DFS channel; and
schedule the uplink traffic away from the DFS channel upon enabling the DFS procedure, wherein scheduling the uplink traffic away from the DFS channel comprises at least one of a ceasing to transmit uplink traffic on the DFS channel or scheduling the uplink traffic on a non-DFS channel.

24. The computer-readable medium of claim 22, wherein the instructions are further executable by the computer to:
disable the DFS procedure based on determining that the UE is receiving downlink traffic on the DFS channel.

25. The computer-readable medium of claim 21, wherein the instructions are further executable by the computer to:
generate a table of a plurality of DFS channels associated with a plurality of wireless networks, wherein the plurality of DFS channels includes the DFS channel, and wherein the plurality of wireless networks includes the wireless network associated with the UE.

26. The computer-readable medium of claim 25, wherein the plurality of DFS channels in the table associated with the plurality of wireless networks are reserved for mission critical system, wherein the mission critical system comprises at least one of a radar or a non-civilian application.

27. The computer-readable medium of claim 21, wherein the current operating frequency of the UE is an unlicensed or shared spectrum; and
wherein the mode of operation comprises utilizing the unlicensed or shared spectrum as a primary carrier, a secondary carrier controlled by a licensed carrier, or the secondary carrier configured to schedule downlink traffic.

28. The computer-readable medium of claim 21, wherein the wireless network associated with the UE includes a public land mobile network (PLMN).

29. An apparatus for wireless communications, comprising:
a processor; and
a memory coupled to the processor, the memory comprising instructions executable by the processor to:
identify, at a user equipment (UE), at least one of a current operating frequency of the UE, a mode of operation of the UE, or a wireless network associated with the UE;
determine whether the UE is operating in a dynamic frequency selection (DFS) channel based on the at least one of the current operating frequency of the UE, the mode of operation of the UE, or the wireless network associated with the UE; and
configure the UE to dynamically enable or disable a DFS procedure based on the determining.

30. The apparatus of claim 29, wherein the instructions are further executable by the processor to:
identify a list of DFS channels in a table associated with the wireless network; and
determine that the current operating frequency of the UE corresponds with at least one channel on the list of DFS channels.
